(19) United States
(12) Patent Application Publication
(10) Pub. No.: US 2025/0054027 A1
(43) Pub. Date: Feb. 13, 2025

(54) INTEGRATED SYSTEM AND METHOD FOR CONTEXTUAL, INTERACTIVE AND REWARDING ADVERTISEMENTS

(71) Applicant: Kunato Inc., New York, NY (US)

(72) Inventor: Illan Poreh, New York, NY (US)

(21) Appl. No.: 18/798,869

(22) Filed: Aug. 9, 2024

Related U.S. Application Data
(60) Provisional application No. 63/531,824, filed on Aug. 10, 2023.

(51) Int. Cl. G06Q 30/0241; G06Q 30/0207; G06Q 30/0251

(52) U.S. Cl. CPC G06Q 30/0276; G06Q 30/0239; G06Q 30/0255; G06Q 30/0261; G06Q 30/0269

(57) ABSTRACT

Techniques for providing a system that seamlessly integrates contextual, interactive and rewarding advertisements into the digital content is disclosed. In one embodiment, a processor is configured to analyze a digital content using a content-aware Artificial Intelligence (AI) to generate a set of contextually relevant advertisements; tailor the set of contextually relevant advertisements using a brand and user-focused AI based on a set of brand guidelines and user preferences; transform the set of contextually relevant advertisements into an interactive puzzle using an image-based puzzle AI; and reward a user engagement with the interactive puzzle, to seamlessly integrates contextual, interactive and rewarding advertisements into the digital content.

### CROSS-REFERENCE TO RELATED APPLICATIONS

This application claims priority to U.S. Provisional Patent Application Ser. No. 63/531,824, entitled “INTEGRATED SYSTEM AND METHOD FOR CONTEXTUAL, INTERACTIVE AND REWARDING ADVERTISEMENTS” filed on Aug. 10, 2023, the disclosures of which are incorporated herein by reference in their entireties.

### TECHNICAL FIELD OF THE INVENTION

The present invention relates generally to the field of digital advertising, and more specifically to an innovative system and method for generating and delivering interactive advertisement content.

### BACKGROUND OF THE INVENTION

In today's digital landscape, traditional, static advertisements are losing their effectiveness due to the oversaturation of information. The lack of personalization and interaction often leads to low engagement rates and a poor user experience. This invention addresses these shortcomings by providing an interactive advertising system that enhances user engagement, personalization, and offers a reward-based incentive mechanism.

### SUMMARY OF THE INVENTION

This invention is a system and method that seamlessly integrates advertisements into the digital content. The advertisements are contextually generated based on the content itself and further tailored using a sophisticated Artificial Intelligence (AI) mechanism to reflect the user's preferences and brand guidelines. It further enhances user engagement by transforming advertisements into interactive puzzles, rewarding users for their interaction with the interactive puzzle.

The invention introduces a revolutionary approach to digital advertising by employing elements of personalization, gamification, incentivization, and real-time updates. The system presents users with a personalized, AI-generated puzzle that aligns with the user's interests and the context of the content. The puzzles not only serve as an engaging form of advertisement but also act as a form of Completely Automated Public Turing test to tell Computers and Humans Apart (CAPTCHA) for user authentication. The CAPTCHA is a challenge-response mechanism to determine if the use is a human or a computer. The inclusion of a reward mechanism provides users with incentives to interact with the advertisements, thus enhancing user engagement and transforming traditional passive advertising into an active, game-like experience.

The present invention is a unique interactive advertisement system that employs AI algorithms for advertisement customization. The AI considers factors such as the user's demographic data, browsing history, and location, along with the context of the content, to generate a personalized and unique advertisement puzzle. This feature ensures that each advertisement puzzle is not only unique but also highly relevant to the user, enhancing user interest and engagement.

The system also includes a reward mechanism that provides incentives to the user to interact with the advertisement puzzles. Rewards such as discount coupons, free products, or other promotional items can be won, which further increases user interaction and engagement.

Real-time updates form an integral part of the system. As users interact with the advertisement puzzles, and they receive immediate feedback on their actions. Updates showing recent winners provide social proof and encourage further engagement from the users. For advertisers, these real-time updates offer valuable insights into campaign performance, enabling them to adjust their strategies as needed. Further, with the user's consent, the system can collect valuable data such as user engagement metrics and contact information. This data can be used for future targeted advertising, thereby enhancing the effectiveness of advertising campaigns.

### BRIEF DESCRIPTION OF DRAWINGS

The invention is explained in further detail, and by way of example, with reference to the accompanying drawings wherein:

FIG. 1 is a flowchart that illustrates the process flow in which various operations of generation of a contextual, interactive, and rewarding advertisements are practiced, in accordance with an exemplary embodiment of the present disclosure.

FIG. 2 is a block diagram that illustrates a system environment in which various operations of a contextual, interactive, and rewarding advertisements are practiced, in accordance with an exemplary embodiment of the present disclosure.

FIG. 3A is a block diagram that illustrates the Content-aware Artificial Intelligence (AI), Brand and user focused Artificial Intelligence (AI) and Image based puzzle Artificial Intelligence (AI) are used to generate puzzle advertisements, in accordance with an exemplary embodiment of the present disclosure.

FIG. 3B is a block diagram that illustrates a system which takes the digital contents and process it through the AI and generate the interactive puzzle advertisements.

FIG. 3C is a block diagram that illustrates a system how a Natural Language Processing (NLP) is used to generate advertisement puzzles.

FIG. 4 is a block diagram that illustrates an example implementation of the invention using data from a crawler and generating tailored advertisements and interactive puzzles using message brokers and databases.

FIG. 5 is a diagram that illustrates a graphical user interface with an advertisement engine page rendered on a user computing device for illustrating interactive advertisements and puzzles, in accordance with an exemplary embodiment of the present disclosure.

FIG. 6 illustrates a system architecture of a computer system for performing operations of a contextual, interactive, and rewarding advertisements, in accordance with an exemplary embodiment of the disclosure.

The drawings described herein are for illustration purposes only and are not intended to limit the scope of the present subject matter in any way.

### DETAILED DESCRIPTION

The present invention will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices or a combination thereof. Accordingly, the present invention may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in an embodiment” or “in one embodiment” as used herein does not necessarily refer to the same embodiment, though it may. Furthermore, the phrase “in another embodiment” as used herein does not necessarily refer to a different embodiment, although it may. Thus, as described below, various embodiments or the invention may be readily combined, without departing from the scope or spirit or the invention. In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” may include singular or plural references. The meaning or “in” includes “in” and ‘on.”

The following is a description of illustrative embodiments that when taken in conjunction with the following drawings will demonstrate the above noted features and advantages, as well as further ones. In the description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

The present invention introduces an advanced AI module or a set of AI modules by incorporating AI into the creation of advertisements brings benefits in terms of scalability, efficiency, and personalization. It allows for the creation of a large number of unique, tailored advertisements in real-time, matching the speed and scale of digital content. Furthermore, the AI module can learn from user engagement data to continuously improve the relevance and effectiveness of the advertisements.

The content-aware Artificial Intelligence (AI) module designed to revolutionize intelligent decision-making and data analysis across diverse applications by leveraging AI's ability to analyze and understand content, each advertisement can be made contextually relevant. This Content-aware Artificial Intelligence (AI) module comprises a sophisticated ensemble of neural network architectures, machine learning algorithms, and/or adaptive models meticulously engineered to comprehend complex patterns, learn from data, and generate actionable insights. Key features of this content-aware Artificial Intelligence (AI) module include its capability to autonomously process vast volumes of structured and unstructured data, enabling real-time decision-making and predictive analytics. Furthermore, the content-aware Artificial Intelligence (AI) module integrates self-learning capabilities, continuously refining its models through adaptive algorithms and reinforcement learning techniques. This ensures that the advertisements are appropriate to the article or page they appear on, thereby avoiding any discordance between the content and the advertisement that might disrupt the user experience.

The brand and user focused Artificial Intelligence (AI) module would be tuned to understand brand guidelines and user preferences. On one hand, brand and user focused Artificial Intelligence (AI) module ensures the puzzle image and the advertisement message align with the brand's image and messaging guidelines. On the other hand, brand and user focused Artificial Intelligence (AI) module tailors the advertisement to the individual user based on available demographic information, geographical location, and potentially even past engagement data and preferences, creating a highly personalized advertisement experience. This brand and user focused Artificial Intelligence (AI) module comprises a sophisticated ensemble of neural network architectures, machine learning algorithms, and/or adaptive models meticulously engineered to comprehend complex patterns, learn from data, and generate actionable insights. Key features of this brand and user focused Artificial Intelligence (AI) module include its capability to autonomously process vast volumes of structured and unstructured data, enabling real-time decision-making and predictive analytics. Furthermore, the brand and user focused Artificial Intelligence (AI) module integrates self-learning capabilities, continuously refining its models through adaptive algorithms and reinforcement learning techniques.

The image based puzzle Artificial Intelligence (AI) module would use an image relevant to the brand, user, and content to create a unique puzzle. The image could be a product, a brand logo, or any other graphic that conveys the brand message. This Image based puzzle Artificial Intelligence (AI) module comprises a sophisticated ensemble of neural network architectures, machine learning algorithms, and/or adaptive models meticulously engineered to comprehend complex patterns, learn from data, and generate actionable insights. Key features of this image based puzzle Artificial Intelligence (AI) module include its capability to autonomously process vast volumes of structured and unstructured data, enabling real-time decision-making and predictive analytics. Furthermore, the image based puzzle Artificial Intelligence (AI) module integrates self-learning capabilities, continuously refining its models through adaptive algorithms and reinforcement learning techniques. In addition, the complexity of the puzzle would be designed to offer a fun challenge without being overly difficult, thus ensuring the user stays engaged.

The present invention introduces an interactive engagement which allow users actively engage with the advertisement puzzle. The image based puzzle Artificial Intelligence (AI) module tailor advertisement puzzles to each user's interests and the content context. In addition, the users can win rewards like discount coupons or free products as user incentive for the advertisement puzzle. In one of the embodiments, the image based puzzle Artificial Intelligence (AI) module collects user engagement data, and potentially contact information with user consent. In another embodiment, the users can unlock premium content by interacting with advertisements.

In another embodiment, the real time updates are provided by using the real-time data on user engagement, wins, and progress of the puzzles. The real-time updates can provide valuable insights for the advertisers into the performance of their advertisement campaign. They can see in real-time how many users are interacting with their advertisements, how many puzzles are being solved, and how many rewards are being won. This allows advertisers to make timely adjustments to their campaign if needed. The real-time updates can provide useful data on user behavior and engagement for the publishers. They can see how long users spend on each advertisement, which puzzles are the most engaging, and what types of rewards are the most attractive. This data can help publishers optimize their content and advertisement strategies. Where advertisements unlock premium content, real-time updates can ensure smooth delivery of the content. Once a user has solved a puzzle or won a reward, the content can be unlocked instantly, enhancing the user experience. Further, real-time updates can enhance user engagement by providing immediate feedback on their interactions with the puzzle advertisements. For example, users can see immediately whether they have successfully solved a puzzle and if they have won a reward. The real-time updates showing that other users have won rewards can provide social proof, encouraging more users to engage with the advertisements in hopes of winning. These updates can include the location and prize details of the winners to create a sense of community and competition.

In another embodiment, the image based puzzle Artificial Intelligence (AI) module offers a multi-stage reward structure. As users engage with advertisements throughout an article, they accumulate points or collect puzzle pieces, increasing their chance of winning. This model not only motivates users to engage with all the advertisements but also incentivizes them to read the entire article. A visible progress tracker can further enhance this experience, providing a sense of achievement as users get closer to winning a reward. Further, the puzzles add an element of fun, their difficulty level is carefully calibrated to avoid frustration. In another embodiment, the frequency of the puzzle is controlled to prevent content disruption.

The invention incorporates AI to generate advertisements based on the user's location, demographics, and preferences, creating a highly targeted and relevant advertisement experience. creates tailored puzzle advertisements, weaving them seamlessly into the user's content consumption process. This personalization improves advertisement relevance, driving higher engagement rates and better advertisement recall.

Further the invention transforms the typically passive advertisement experience into an interactive game. Each advertisement is presented as a puzzle that the user must solve to progress. This active participation demands cognitive engagement, which leads to better brand recall and message retention. Furthermore, gamification adds an element of fun to the advertisement experience, enhancing user perception of the brand and increasing the likelihood of repeat interactions. By solving the puzzle, Users stand a chance to win a reward, by solving a puzzle, which could be a discount coupon or a free product. This incentivization acts as a powerful motivator, driving users to engage repeatedly with the advertisements in hopes of winning a prize. In addition, it also offers a compelling reason for users to willingly provide their contact information, enabling future marketing efforts.

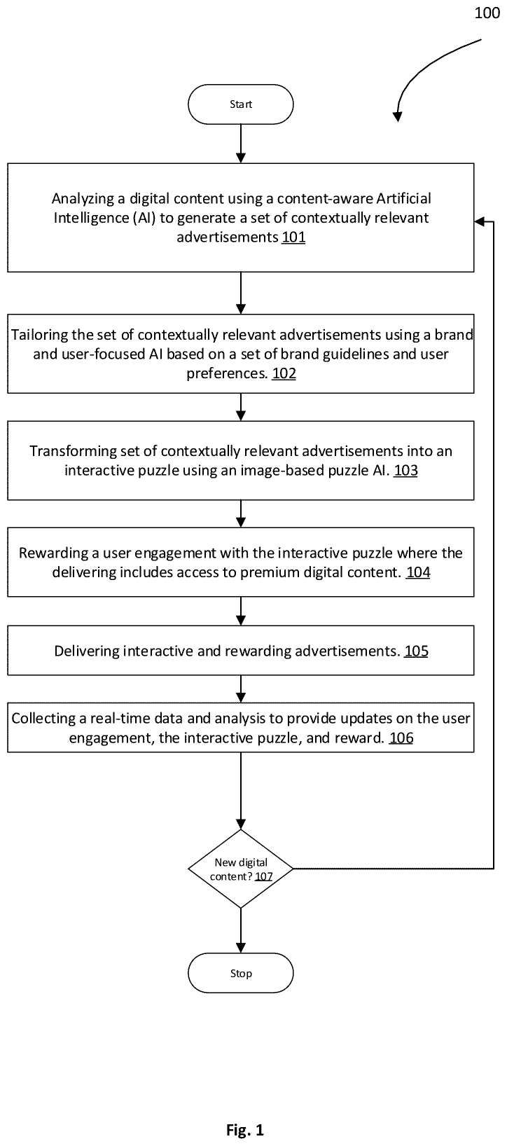

FIG. 1 is a flowchart that illustrates a process flow 100 in which various operations of generation of a contextual, interactive, and rewarding advertisements are practiced, in accordance with an exemplary embodiment of the present disclosure.

FIG. 1 describes the process of analyzing a digital content using a content-aware Artificial Intelligence (AI) to generate a set of contextually relevant advertisements 101, tailoring the set of contextually relevant advertisements using a brand and user-focused AI based on a set of brand guidelines and user preferences 102, transforming a set of contextually relevant advertisements into an interactive puzzle using an image-based puzzle AI 103, and rewarding a user engagement with the interactive puzzle 104. At step 105, the advertisement engine performs operation of delivering interactive and rewarding advertisements. At step 106, the advertisement engine performs operation of collecting a real-time data and analysis to provide updates on the user engagement, the interactive puzzle, and reward. At step 107, the advertisement engine performs a check to determine whether there are more digital contents. If there are more digital contents then step 101 is performed, else the process flow is terminated.

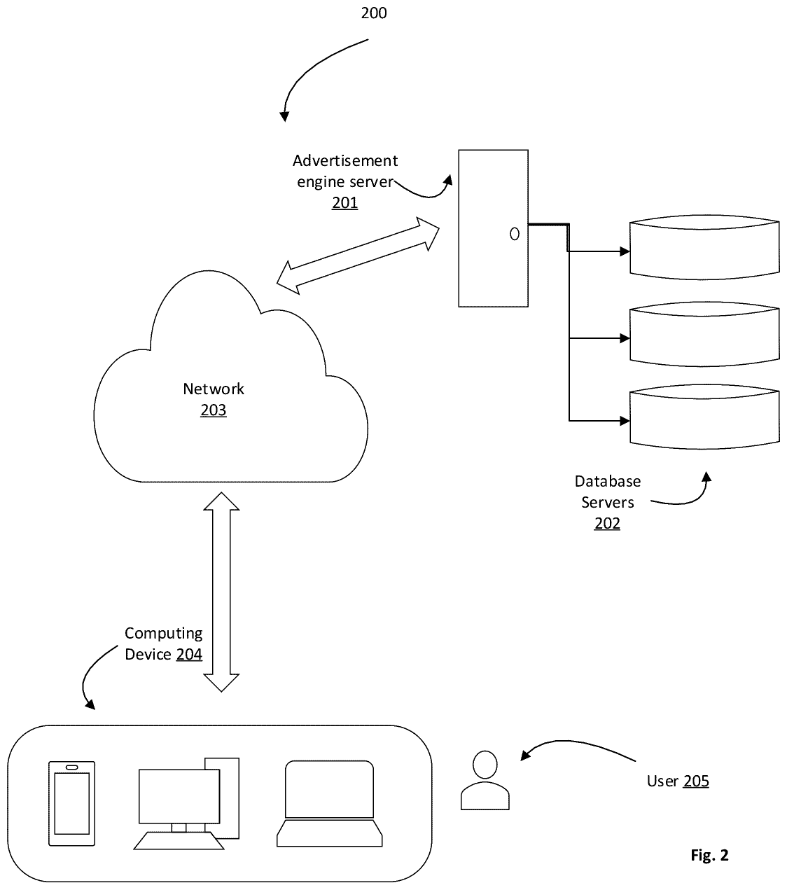

FIG. 2 is a block diagram that illustrates a system environment 200 in which various operations of generation of a contextual, interactive, and rewarding advertisements are practiced, in accordance with an exemplary embodiment of the present disclosure. The system environment 200 includes one or more application or computing servers such as an advertisement engine server 201, one or more database servers such as a database server 202, and one or more networks such as a network 203. The system environment 100 further includes one or more user computing devices associated with one or more users such as a user computing device 204 associated with a user 205. Examples of the user computing device 205 may include a smartphone, a tablet computer, a laptop, or any other portable communication device. The advertisement engine server 201 and the user computing device 205 may be configured to communicate with each other over a communication network such as the network 203. The advertisement engine server 201 and the database server 202 may also communicate with each other over the same network 203 or a different network.

The advertisement engine server 201 is a computing device, a software framework, or a combination thereof, that may provide a generalized approach to create the application server implementation. Examples of the advertisement engine server 201 include, but are not limited to, a personal computer, a laptop, or a network of computer systems. The advertisement engine server 201 may be realized through various web-based technologies such as, but not limited to, a Java web-framework, a .NET framework, a PHP (Hypertext Preprocessor) framework, or any other web-application framework. The advertisement engine server 201 may operate on one or more operating systems such as Windows, Android, Unix, Ubuntu, Mac OS, or the like. Various operations of the advertisement engine server 201 may be dedicated to execution of procedures, such as, but are not limited to, programs, routines, or scripts stored in one or more memory units for supporting its applied applications and performing one or more operations.

In an embodiment, the advertisement engine server 201 may be configured to enable generation of a contextual, interactive, and rewarding advertisements in an online manner. The generation of a contextual, interactive, and rewarding advertisements may be performed by means of the Internet advertisement engine that is implemented, supported, and presented by the advertisement engine server 201 on the one or more user computing devices such as the user computing device 204. In an exemplary embodiment, the advertisement engine server 201 may be configured to execute a computer program (i.e., an advertisement engine program) to implement one or more aspects of the advertisement engine. For example, the computer program may create and manage databases and data tables that store data used by the computer program. The computer program may include instructions for the advertisement engine server 201 to execute to implement the methods and processes associated with various aspects of the present disclosure. The computer program may be tangibly embodied on a computer readable medium such as a magnetic disk, a magneto-optical disk, a flash memory, a random-access memory, a read only memory, a programmable read only memory, an erasable programmable read only memory, or the like. The computer program further permits the network users, upon navigating to the advertisement engine web server URL or sites on other web servers or the advertisement application running on the user computing device 204 capable of submitting queries to the advertisement engine server 201 through their browser program or application, to type keyword queries to identify digital content items of interest among the millions of digital content items that are available on the World Wide Web (WWW) or the database server 202. In an exemplary embodiment, the advertisement engine server 201 may be configured to generate an advertisement result that includes at least one or more relevant digital content items obtained from the World Wide Web (WWW) or the database server 202. The advertisement engine server 201 may be further configured to generate a list of interactive puzzles corresponding to the digital content items that contain information relevant to keywords entered by the user 205 at the user computing device 204. The advertisement engine server 201 may be further configured to transmit or present this interactive puzzle, in the form of a web page or interface page (hereinafter, may be referred to as an interactive puzzle page), to the user 205, where it is displayed on a browser or application running on the user computing device 204.

In an embodiment, the advertisement engine server 201 may be configured to integrate the advertisement engine with a search bar. The search bar may be provided for receiving one or more keywords from the one or more users. For example, the search bar may be utilized by the one or more users (such as the user 205) to input or provide the one or more keywords to the advertisement engine server 201 for accessing or searching the digital content items. The advertisement engine server 201 may be further configured to process the one or more keywords to identify or select the relevant digital content items from the World Wide Web (WWW) and/or the database server 202. After processing the one or more keywords, the advertisement engine server 201 may be further configured to generate and present an interactive advertisement puzzle to the user 205. The interactive advertisement puzzle result page may include the relevant digital content items associated with the one or more keywords searched by the user 205.

In an embodiment, the advertisement engine server 201 may be further configured to integrate the advertisement engine with a plurality of AI modules. The plurality of advertisement modules may include at least a content-aware Artificial Intelligence (AI), a brand and user focused Artificial Intelligence (AI), and image based puzzle Artificial Intelligence (AI) for generating interactive puzzle advertisements.

The database servers 202 may include suitable logic, circuitry, interfaces, and/or code, executable by the circuitry that may be configured to perform one or more data management and storage operations such as receiving, storing, processing, and transmitting queries, data, content, algorithms, code, or the like. In an embodiment, the database server 202 may be a data management and storage computing device that is communicatively coupled to the advertisement engine server 201 or the user computing device 204 via the network 203 to perform the one or more data management and storage operations.

In an exemplary embodiment, the database servers 202 may be configured to manage and store one or more search queries searched by the one or more users on the content search engine. The database servers 202 may be further configured to manage and store digital content data. The database servers 202 may be further configured to manage and store one or more words (search terms) and their associated classification and synonyms according to a type of speech. The classifications may include that the term is a noun, verb, adjective, or the like. The database servers 202 may be further configured to manage and store one or more profiles of the one or more users who are registered on the search engine. Each profile may include information such as a user's name, number, email, preferences, channels, followers, followings, or the like. In some embodiments, each profile may include reward balance of the user. In some embodiments, each profile may further include rewards earned, rewards spent etc. In another embodiments, each profile may further include rewards history of the user. In an exemplary embodiment, the database servers 202 may be further configured to manage and store rewards history of the one or more users. In an exemplary embodiment, the database servers 202 may be further configured to manage and store one or more puzzles to perform the one or more CAPTCHA operations in real time. In an exemplary embodiment, the database serves 202 may be further configured to manage and store one or more advertisements. The database servers 202 may be implemented by means of a personal computer, a laptop, or a network of computer systems. Examples of the database servers 202 may include, but are not limited to, MongoDB, Cassandra, and HBase, or Structured Query Language (SQL) database.

The network 203 may include suitable logic, circuitry, interfaces, and/or code, executable by the circuitry that may be configured to transmit messages and requests between various entities, such as the advertisement engine server 201, the database servers 202, and the user computing device 204. Examples of the network 203 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 200 may connect to the network 203 in accordance with various wired and wireless communication protocols, such as Transmission Control Protocol and Internet Protocol (TCP/IP), User Datagram Protocol (UDP), Long Term Evolution (LTE) communication protocols, or any combination thereof.

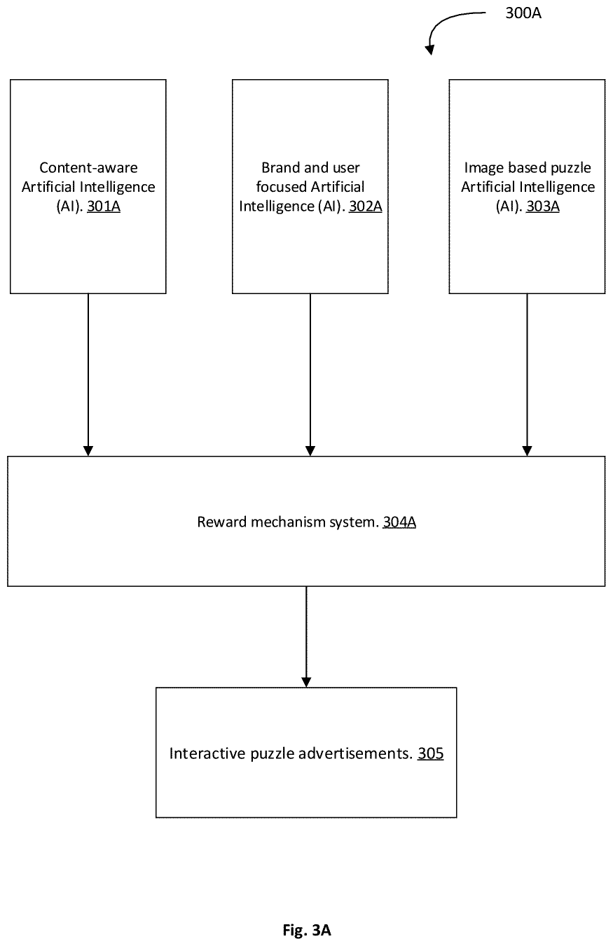

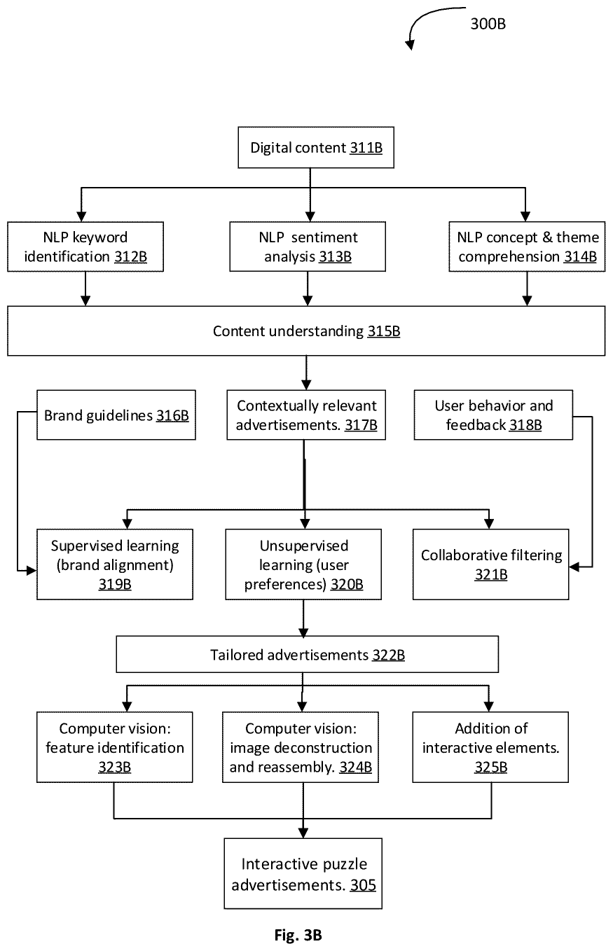

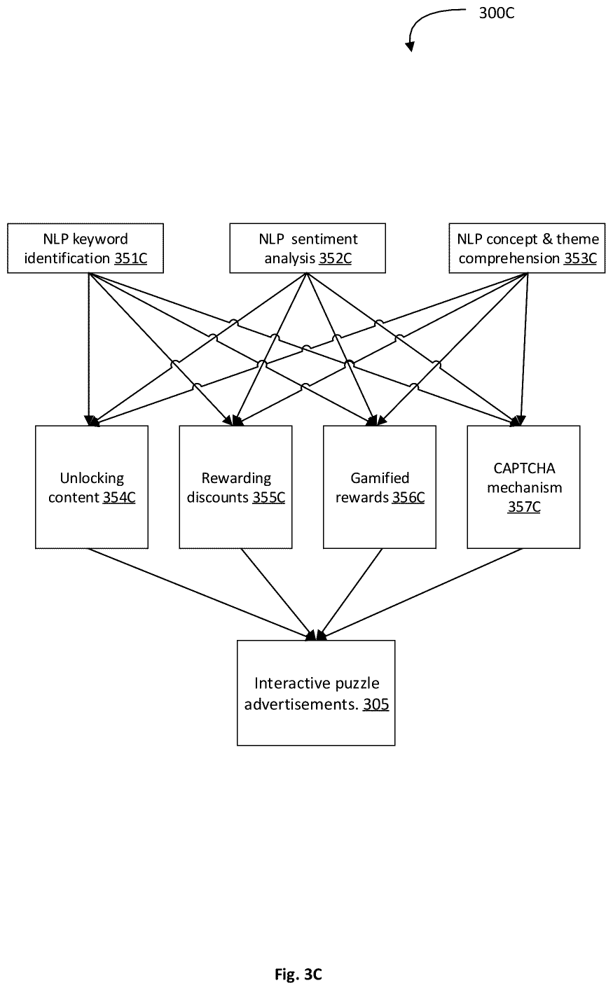

FIG. 3A is a block diagram 300A that illustrates the content-aware Artificial Intelligence (AI), brand and user focused Artificial Intelligence (AI), and image based puzzle Artificial Intelligence (AI) are used to generate puzzle advertisements, in accordance with an exemplary embodiment of the present disclosure. The disclosed invention presents an innovative streamlined operational sequence within a system. The flowchart comprises distinct components labeled as content-aware Artificial Intelligence (AI) 301, brand and user focused Artificial Intelligence (AI) 302, and image based puzzle Artificial Intelligence (AI) 303, representing specific stages, processes, or functionalities within the system. These components directly converge into a reward mechanism system 304A, generating a reward mechanism.

The content-aware Artificial Intelligence (AI) 301, brand and user focused Artificial Intelligence (AI) 302, and image based puzzle Artificial Intelligence (AI) 303 each contribute to the reward mechanism system 304A, with their outputs or processes converging toward reward mechanism system 304A. The reward mechanism system 304A acts as a pivotal point or processing stage, receiving inputs from c-aware Artificial Intelligence (AI) 301, brand and user focused Artificial Intelligence (AI) 302, and image based puzzle Artificial Intelligence (AI) 303, and interacting with interactive puzzle advertisements 305 to generate interactive advertisements. The interactive puzzle advertisements 305 represent generating an interactive puzzle based on the inputs received from the AI units. The flowchart embodies a streamlined and efficient operational sequence, enabling seamless data flow and operation progression within the system.

FIG. 3B is a block diagram 300B that illustrates a system which takes the digital contents and process it through the AI and generate the interactive puzzle advertisements. The block diagram 300B presents a multifaceted operational sequence within a system. The NLP keyword identification 351C, NLP sentiment analysis 352C and NLP concept & theme comprehension 353C are used for unlocking content 354C, rewarding discounts 355C, gamified rewards 356C, and as a CAPTCHA mechanism 357C. Furthermore, unlocking content 354C, rewarding discounts 355C, gamified rewards 356C, and as a CAPTCHA mechanism 357C forms part of the interactive puzzle advertisements 305.

FIG. 3C is a block diagram 300C that illustrates a system how a Natural Language Processing (NLP) is used to advertisement puzzles. The content understanding 315B is performed on the digital content 311B, by methods of NLP keyword identification 312B, NLP sentiment analysis 313B, and/or NLP concept & theme comprehension 314B. The content understanding 315B is used to generate contextually relevant advertisements 317B. Further, tailored advertisements 322B are generated using the contextually relevant advertisements 317B by performing supervised learning (brand alignment) 319B, unsupervised learning (user preferences) 320B, and collaborative filtering 321B, on the contextually relevant advertisements 317B. Furthermore, Interactive puzzle advertisements 305 are generated after performing steps of computer vision: feature identification 323B, computer vision: image deconstruction and reassembly 324B, and/or addition of interactive elements 325B. The steps of computer vision: feature identification 323B, computer vision: image deconstruction and reassembly 324B, and/or addition of interactive elements 325B are performed on the tailored advertisements 322B.

In an embodiment, brand guidelines 316B is used to generate tailored advertisements 322B using the contextually relevant advertisements 317B by performing supervised learning (brand alignment) 319B.

In another embodiment, user behavior and feedback 318B is used to generate tailored advertisements 322B using the contextually relevant advertisements 317B by performing collaborative filtering 321B.

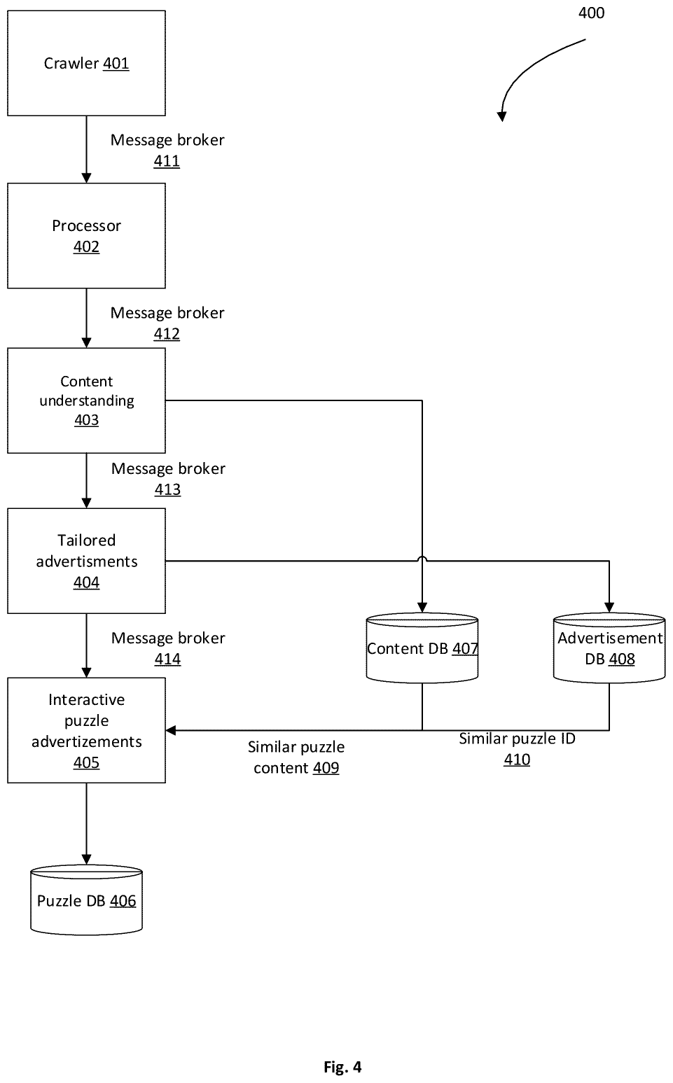

FIG. 4 is a block diagram 400 that illustrates an example implementation of the invention using data from a crawler and generating tailored advertisements and interactive puzzles using message brokers and databases, in accordance with an exemplary embodiment of the disclosure. A crawler 401 collects Uniform Resource Locators (URLs) from multiple sources, scrapes their raw Hypertext Markup Language (HTML) and sends it across on Message broker (e.g.: RabbitMQ) to a processor 402. The processor will take the raw HTML as input, and parse it to extract the content and the meta data of the article. The Content Understanding 403 indexes the article information and vectors, so that it's readily available to query in a way that similar articles can be retrieved, then uses Message broker to signal that the article is ready to be presented with tailored advertisements 404 and interactive puzzle advertisements 405. A content Database (DB) 407 keeps updated by the content understanding 403, and an advertisement DB 408 is maintained for the interactive advertisements by the tailored advertisements 404. The interactive puzzle advertisements 405 use the content Database (DB) 407 and the advertisement DB 408 to generate interactive puzzles. Further, a puzzle DB 406 is maintained by the interactive puzzle advertisements 405.

In an exemplary embodiment, similar puzzle content 409, and similar puzzle ID 410 may be generated and stored in the Puzzle DB 406. The similar puzzle content 409, and similar puzzle ID 410 data could be derived from the content Database (DB) 407 and the advertisement DB 408, with the inputs from the content understanding 403, and tailored advertisements 404.

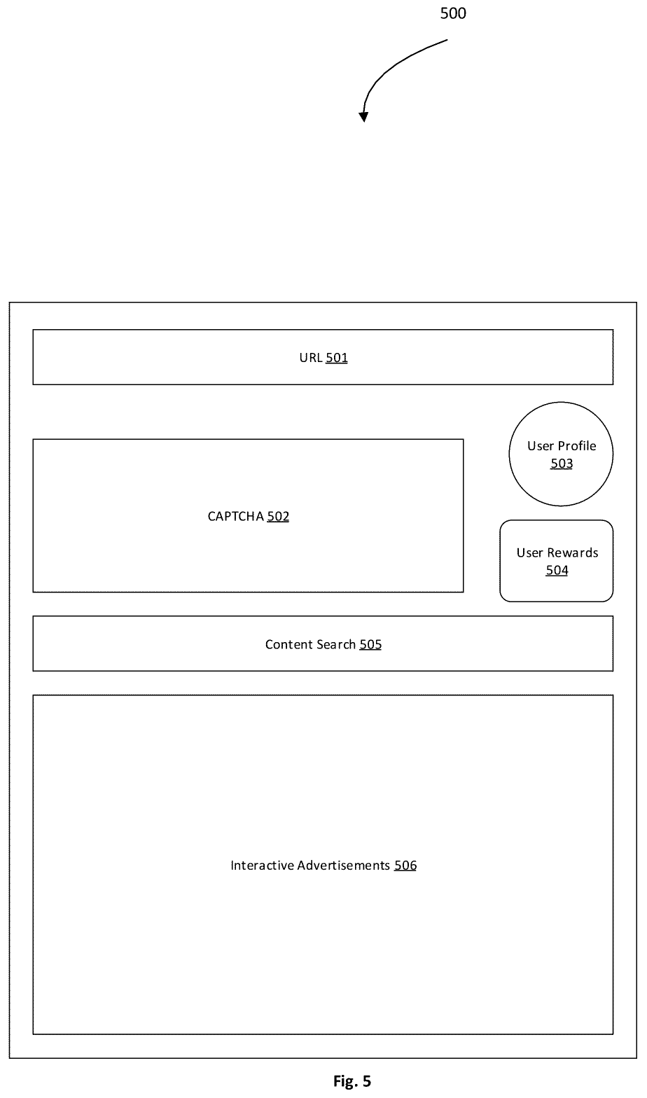

FIG. 5 is a diagram that illustrates a graphical user interface 500 with an advertisement engine page rendered on the user computing device 204 for illustrating the interactive advertisements and puzzles, in accordance with an exemplary embodiment of the disclosure. In an embodiment, the advertisement engine server 201 may be configured to render the advertisement engine page on the user computing device 204. In one example, the advertisement engine page may be rendered on the user computing device 204 when the user 110 logs into the search engine by using his or her login credentials. After receiving the login credentials from the user 205, the advertisement engine server 201 may be configured to validate the login credentials of the user 205. Post the successful validation of the login credentials of the user 205, the search engine server 201 may render the search engine page on the user computing device 204. As shown, the advertisement engine server 201 may include one or more tools or components of the advertisement engine on the advertisement engine page. These tools or components of the advertisement engine may be utilized by the user 205 to perform one or more interactive operations on the advertisements and/or interactive puzzle.

In an exemplary embodiment, the advertisement engine page 500 may include the content search bar 505. The content search bar 505 may be provided for receiving the one or more keywords from the one or more users. For example, the search bar 505 may be utilized by the user 205 to provide one or more keywords to the advertisement engine for searching the digital content items. Based on processing of the one or more keywords, the advertisement engine may present the result page to the user 205. The result page may include the relevant digital content items associated with the one or more keywords, interactive advertisements, and interactive puzzles. Further, the advertisement engine page may include user rewards 504 which give details about the rewards earned and used by the user 205.

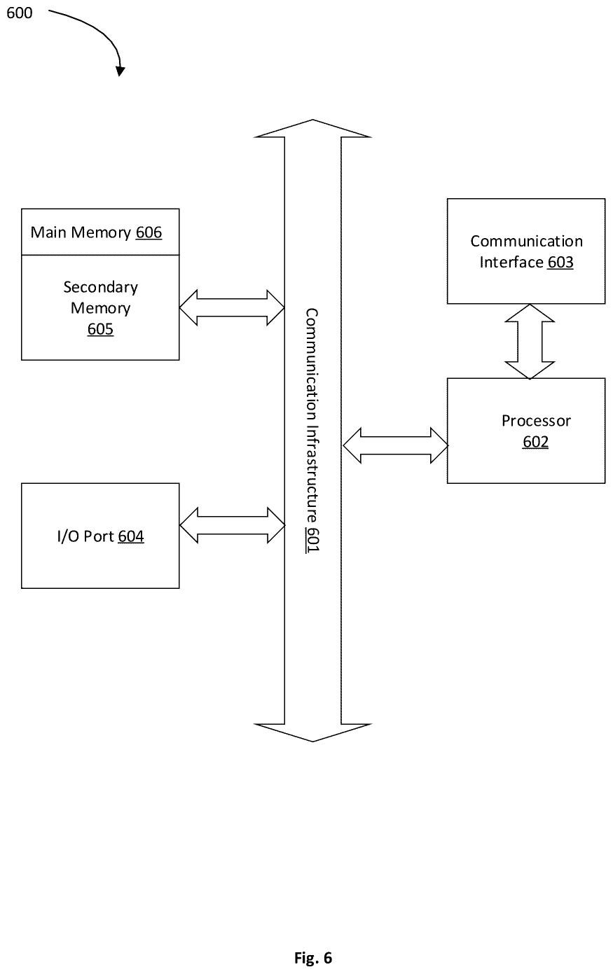

FIG. 6 is a block diagram that illustrates a system architecture of a computer system 600 for performing advertisement engine operations, in accordance with an exemplary embodiment of the disclosure. An embodiment of the disclosure, or portions thereof, may be implemented as computer readable code on the computer system 600. In one example, the advertisement engine server 201 or the database server 202 of FIG. 2 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the advertising operations and features as described above in conjunction with FIGS. 1, 3A-3C, and 4.

The computer system 600 may include a processor 602 that may be a special purpose or a general-purpose processing device. The processor 602 may be a single processor, multiple processors, or combinations thereof. The processor 602 may have one or more processor “cores.” Further, the processor 602 may be coupled to a communication infrastructure 601, such as a bus, a bridge, a message queue, multi-core message-passing scheme, a communication network, a CAN bus, or the like. The computer system 600 may further include a main memory 606 and a secondary memory 605. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 600 may further include an input/output (I/O) port 604 and a communication interface 601. The I/O port 604 may include various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 601 may be configured to allow data to be transferred between the computer system 600 and various devices that are communicatively coupled to the computer system 600. Examples of the communication interface 601 may include a modem, a network interface, i.e., an Ethernet card, a communication port, and the like. Data transferred via the communication interface 601 may be signals, such as electronic, electromagnetic, optical, or other signals as will be apparent to a person skilled in the art. The signals may travel via a communications channel, such as the CAN bus, which may be configured to transmit the signals to the various devices that are communicatively coupled to the computer system 600. Examples of the communication channel may include a wired, wireless, and/or optical medium such as cable, fiber optics, a phone line, a cellular phone link, a radio frequency link, and the like. The main memory 606 and the secondary memory 605 may refer to non-transitory computer readable mediums that may provide data that enables the computer system 600 to implement the advertising operations and features as described above in conjunction with FIGS. 1, 3A-3C, and 4.

In one of the embodiments on the implementation of the invention, a crawler collects Uniform Resource Locators (URLs) from multiple sources, scrapes their raw Hypertext Markup Language (HTML) and sends it across on message broker (e.g.: RabbitMQ, Apache Kafka, ZeroMQ, etc.) to the processor. The processor will take the raw HTML as input, and parse it to extract the content and the meta data of the article. Further, the advertisement engine server indexes the article information and vectors, so that it's readily available to query in a way that similar articles can be retrieved, then uses message broker to signal that the article is ready to be presented with tailored advertisements and interactive puzzle advertisements.

The tailored advertisement module stores the content and the meta data of the article in an advertisement database. The content advertising module store the content and the meta data of the article in a content database. In addition, the tailored advertisement module forwards the output to an interactive puzzle advertisement module wherein the interactive puzzle advertisement module uses the received data to generate interactive puzzles. Further, the interactive puzzle advertisement module stores the data into a puzzle database.

In one of the embodiments, the disclosed invention pertains to a dedicated hardware system designed specifically for accelerated and optimized artificial intelligence (AI) processing. This specialized hardware architecture comprises a series of integrated circuits, processors, and memory units engineered to execute AI algorithms with enhanced efficiency, speed, and scalability. The hardware configuration incorporates parallel processing units tailored for matrix operations, enabling rapid execution of neural network models and complex AI computations. Furthermore, the system includes dedicated instruction sets and optimized data pathways, facilitating seamless integration with AI frameworks and software libraries. The innovation focuses on minimizing latency and maximizing throughput for AI workloads, providing a purpose-built solution to meet the computational demands of AI applications across diverse domains.

In another embodiment, the invention disclosed herein seamlessly integrate and optimize operations within hybrid cloud environments. This innovative technology encompasses a versatile architecture that efficiently interfaces with both private and public cloud infrastructures, enabling dynamic workload distribution, resource allocation, and data management across hybrid cloud deployments. Key aspects include specialized adaptability mechanisms facilitating secure and efficient data exchange between on-premises and off-premises cloud components. The system further comprises dynamic scalability features, allowing for on-demand resource provisioning and elastic scaling across the hybrid cloud landscape. Additionally, the invention incorporates intelligent workload orchestration and policy-based management functionalities, ensuring optimal performance and resource utilization while maintaining compliance with diverse regulatory frameworks. This inventive hybrid cloud support redefines the operational paradigms of cloud computing, offering unparalleled flexibility, scalability, and security for applications and services operating within hybrid cloud environments.

In another embodiment, the invention could be deployed in a microservice architecture designed to revolutionize application development and deployment paradigms. This innovative architecture comprises a collection of independently deployable, loosely coupled services, each encapsulating distinct business functionalities or processes. These microservices communicate through well-defined APIs, fostering modularity, flexibility, and scalability within complex software systems. Key aspects of this architecture include the decentralized nature of microservices, allowing for rapid development, deployment, and updating of individual components without impacting the entire system. Furthermore, the invention incorporates sophisticated orchestration and service discovery mechanisms, enabling seamless integration, fault tolerance, and horizontal scaling across distributed computing environments. The innovation also emphasizes the adoption of containerization and container orchestration frameworks, facilitating efficient resource utilization and management. This inventive microservice architecture redefines application design principles, offering enhanced agility, maintainability, and scalability for modern software ecosystems.

In another embodiment, the invention introduces a sophisticated system and method tailored to optimize operations within containerized computing environments. This innovative technology encompasses a comprehensive framework designed for seamless orchestration, management, and scalability of container-based applications. Key features of the invention include a robust container orchestration system capable of dynamically deploying, scaling, and managing containerized workloads across distributed computing infrastructures. Furthermore, the system incorporates intelligent resource allocation mechanisms, ensuring efficient utilization of compute, storage, and networking resources while adapting to changing demands and constraints. The invention also integrates advanced containerization technologies, providing isolation, portability, and encapsulation of application components within lightweight, standardized containers. Additionally, the system incorporates comprehensive security measures, including access controls, encryption, and policy enforcement, ensuring the integrity and confidentiality of containerized workloads. This inventive support for container environments redefines the paradigms of application deployment and management, offering enhanced agility, resource efficiency, and scalability for modern computing ecosystems.

In another embodiment, the invention described in the process 100 embodied as an Application Programming Interface (API), designed to facilitate seamless integration and interaction with software applications and web applications which require interactive advertisements and puzzles for band endorsements. This API encompasses a set of well-defined functionalities, methods, and protocols allowing external systems, applications, or developers to access, utilize, and leverage the capabilities of advertisement engine server 201 within their respective environments. Key features of this API include its standardized interfaces, enabling interoperability and ease of integration across diverse software platforms and systems. Furthermore, the API provides comprehensive documentation, exemplar use cases, and development resources, empowering developers to effectively harness the functionalities of advertisement engine server 201 in their applications. This inventive API framework redefines the accessibility and utilization of advertisement engine server 201, offering a standardized, user-friendly interface for harnessing its functionalities across a wide spectrum of applications and industries.

In another embodiment, the invention described in the process 100 embodied as an Software Development Kit (SDK) designed to empower developers, enabling them to seamlessly integrate, extend, and leverage the functionalities of advertisement engine server 201 within their software applications. This SDK comprises a comprehensive suite of tools, libraries, APIs, and pre-built modules meticulously crafted to facilitate the swift adoption and utilization of advertisement engine server 201 capabilities. Key features of this SDK include intuitive interfaces, documentation, and sample codes, fostering ease of implementation and rapid prototyping for developers across diverse platforms and programming languages.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, an Internet advertisement engine that is integrated with various features, tools, or components for enabling a user to perform an easy, enhanced, reliable, and quality generation of advertisements. While various exemplary embodiments of the disclosed systems have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A system, comprising:
a processor configured to:
analyze, by the processor, a digital content using a content-aware Artificial Intelligence (AI) to generate a set of contextually relevant advertisements;
tailor, by the processor, the set of contextually relevant advertisements using a brand and user-focused AI based on a set of brand guidelines and user preferences;
transform, by the processor, set of contextually relevant advertisements into an interactive puzzle using an image-based puzzle AI; and
reward, by the processor, a user engagement with the interactive puzzle, wherein the reward includes access to premium digital content.

2. The system of claim 1, wherein the set of contextually relevant advertisements are integrated into the digital content.

3. The system of claim 1, wherein the reward includes access to premium digital content.

4. The system of claim 1, the processor is further configured to collect a real-time data and analysis of the real-time data to provide updates on the user engagement, the interactive puzzle, and reward.

5. The system of claim 1, the processor is further configured to deliver set of interactive and rewarding advertisements.

6. The system of claim 1, the processor is further configured to authorize a user based on the interactive puzzle.

7. The system of claim 6, the processor is further configured to use the user's demographic data, browsing history, and location to generate the interactive puzzle.

8. A method comprising:
analyzing, by a processor, a digital content using a content-aware Artificial Intelligence (AI) to generate a set of contextually relevant advertisements;
tailoring, by the processor, the set of contextually relevant advertisements using a brand and user-focused AI based on a set of brand guidelines and user preferences;
transforming, by the processor, set of contextually relevant advertisements into an interactive puzzle using an image-based puzzle AI; and
rewarding by the processor, a user engagement with the interactive puzzle.

9. The method of claim 8, wherein the set of contextually relevant advertisements are integrated into the digital content.

10. The method of claim 8, wherein the rewarding includes access to premium digital content.

11. The method of claim 8, further comprises collecting a real-time data and analyzing the real-time data to provide updates on the user engagement, the interactive puzzle, and reward.

12. The method of claim 8, further comprises delivering set of interactive and rewarding advertisements.

13. The method of claim 8, further comprises authorizing a user based on the interactive puzzle.

14. The method of claim 13, further comprises using the user's demographic data, browsing history, and location to generate the interactive puzzle.

15. A non-transitory computer-readable medium having computer readable program code embodied thereon, the computer-readable program code, when executed by a processor, causes the processor to perform:
analyzing, by the processor, a digital content using a content-aware Artificial Intelligence (AI) to generate a set of contextually relevant advertisements;
tailoring, by the processor, the set of contextually relevant advertisements using a brand and user-focused AI based on a set of brand guidelines and user preferences;
transforming, by the processor, set of contextually relevant advertisements into an interactive puzzle using an image-based puzzle AI; and
rewarding by the processor, a user engagement with the interactive puzzle.

16. The non-transitory computer-readable medium of claim 15, wherein the set of contextually relevant advertisements are integrated into the digital content.

17. The non-transitory computer-readable medium of claim 15, wherein the reward includes access to premium digital content.

18. The non-transitory computer-readable medium of claim 15, the processor is further configured to collect a real-time data and analysis of the real-time data to provide updates on the user engagement, the interactive puzzle, and reward.

19. The non-transitory computer-readable medium of claim 15, the processor is further configured to deliver set of interactive and rewarding advertisements.

20. The non-transitory computer-readable medium of claim 15, the processor is further configured to authorize a user based on the interactive puzzle.
